(19) United States
(12) Patent Application Publication
(10) Pub. No.: US 2019/0295128 A1
(43) Pub. Date: Sep. 26, 2019

(54) TARGET INSIGHT MEDIA ENGINE

(71) Applicant: International Business Machines Corporation, Armonk, NY (US)

(72) Inventors: Leonard G. Polhemus, JR., Wappingers Falls, NY (US); Kyle Balkissoon, New York, NY (US); Daniel B. Yawitz, New York, NY (US); Catherine M. Reese, Alexandria, VA (US)

(21) Appl. No.: 15/935,310

(22) Filed: Mar. 26, 2018

(51) Int. Cl. G06Q 30/02; G06N 99/00

(52) U.S. Cl. CPC G06Q 30/0261; G06Q 30/0252; G06N 99/005

(57) ABSTRACT

A system, method, and computer program product may identify a preferred geographic area for targeted advertising for a given brand to a targeted consumer. A set of locations of residences of actual consumers of physical brand locations may first be determined. The actual distance traveled by the consumer to the physical brand location is calculated based on the determined residence locations. A sphere of influence for the physical location is identified and a set of geographic areas within the sphere of influence is selected as a target area in which to perform targeted advertising for the particular brand.

### BACKGROUND

The present disclosure relates to targeted advertising, and more specifically, to targeted advertisement based on weather and customer reach for a particular brand.

Targeted advertising is a form of advertising where online advertisers can use sophisticated methods to target receptive audiences with certain traits, often based on the product or person the advertiser is promoting. These traits maybe demographic, which may focus on aspects such as income level, location, employment type, or other demographic features, or psychographic, which may focus on the values, personality or attitude of a consumer who has opted-in to allowing their data to be used for such commercial purposes.

Weather-specific technology may empower brands by utilizing customer campaign triggers to anticipate consumer demand and capture market opportunity in anticipation of a weather pattern or the moment weather strikes. Some technologies may use forecast elements such as temperature, wind speed, precipitation, and humidity to launch paid search and display ads based on the real-time weather outside consumers' doors.

### SUMMARY

Embodiments of the present disclosure may be directed toward a method for identifying a preferred geographic area for a targeted advertising of a given brand to a target consumer. The method may include determining a set of locations of residences of actual customers. Actual customers may be users who have visited a particular physical location of a given brand. Then an actual distance traveled to the particular physical location of the given brand by the actual customers may be calculated. This calculation may be based on the set of locations of residences of the customers. A sphere of influence (SOI) may be identified based on the calculations of the particular physical location and a set of geographic areas within the SOI may be selected as target areas, where the target areas are areas in which to perform the targeted advertising for the particular brand.

Other aspects of the disclosure may be directed toward a method for identifying a set of demographic profiles for a set of individuals within the target areas. This may include using the SOI and look-alike modeling to more accurately pinpoint geographic areas outside of the identified SOI for targeted advertising. Demographic data and modeling can be used to identify geographic areas like zip codes outside of a current customer base.

Other aspects of the disclosure may be directed toward a method for applying weather data to a machine learning system in order to identify a set of weather-based advertising triggers. Thus, current weather data may be used to generate a set of location and content based triggers. The weather-based advertising triggers are predictive of which set of advertisements are preferred for a current weather pattern in the target areas.

In embodiments, the set of locations of residence of actual consumers may be determined by identifying an average geographic location for a user between a certain time period (for example, early in the morning), and assigning it as the location of residence for a user. The method may then involve determining that a user is an actual customer of an actual brand and assigning as a data point the location of residence of the user as one of an actual customer.

Embodiments of the present disclosure may be directed toward a system for identifying a preferred geographic area for a targeted advertising of a given brand to a target consumer. The system may include engines configured to determine a set of locations of residences of actual customers. Actual customers may be users who have visited a particular physical location of a given brand. Then an actual distance traveled to the particular physical location of the given brand by the actual customers may be calculated. This calculation may be based on the set of locations of residences of the customers. A sphere of influence (SOI) may be identified based on the calculations of the particular physical location and a set of geographic areas within the SOI may be selected as target areas, where the target areas are areas in which to perform the targeted advertising for the particular brand.

Other aspects of the disclosure may be directed toward a system for identifying a set of demographic profiles for a set of individuals within the target areas. This may include using the SOI and look-alike modeling to more accurately pinpoint geographic areas outside of the identified SOI for targeted advertising. Demographic data and modeling can be used to identify geographic areas like zip codes outside of a current customer base.

Other aspects of the disclosure may be directed toward a system for applying weather data to a machine learning system in order to identify a set of weather-based advertising triggers. Thus, current weather data may be used to generate a set of location and content based triggers. The weather-based advertising triggers are predictive of which set of advertisements are preferred for a current weather pattern in the target areas.

In embodiments, the system may be configured to perform a method, wherein the set of locations of residence of actual consumers may be determined by identifying an average geographic location for a user between a certain time period (for example, early in the morning), and assigning it as the location of residence for a user. The method may then involve determining that a user is an actual customer of an actual brand and assigning as a data point the location of residence of the user as one of an actual customer.

A computer program product comprising a computer readable storage medium having program instructions embodied therewith, wherein the computer readable storage medium is not a transitory signal per se, the program instructions executable by a processor to cause the processor to perform a method for identifying a preferred geographic area for a targeted advertising of a given brand to a target consumer. The method may include determining a set of locations of residences of actual customers. Actual customers may be users who have visited a particular physical location of a given brand. Then an actual distance traveled to the particular physical location of the given brand by the actual customers may be calculated. This calculation may be based on the set of locations of residences of the customers. A sphere of influence (SOI) may be identified based on the calculations of the particular physical location and a set of geographic areas within the SOI may be selected as target areas, where the target areas are areas in which to perform the targeted advertising for the particular brand.

Other aspects of the disclosure may be directed toward a method for identifying a set of demographic profiles for a set of individuals within the target areas. This may include using the SOI and look-alike modeling to more accurately pinpoint geographic areas outside of the identified SOI for targeted advertising. Demographic data and modeling can be used to identify geographic areas like zip codes outside of a current customer base.

Other aspects of the disclosure may be directed toward a method for applying weather data to a machine learning system in order to identify a set of weather-based advertising triggers. Thus, current weather data may be used to generate a set of location and content based triggers. The weather-based advertising triggers are predictive of which set of advertisements are preferred for a current weather pattern in the target areas.

In embodiments, the set of locations of residence of actual consumers may be determined by identifying an average geographic location for a user between a certain time period (for example, early in the morning), and assigning it as the location of residence for a user. The method may then involve determining that a user is an actual customer of an actual brand and assigning as a data point the location of residence of the user as one of an actual customer.

The above summary is not intended to describe each illustrated embodiment or every implementation of the present disclosure.

### BRIEF DESCRIPTION OF THE DRAWINGS

The drawings included in the present application are incorporated into, and form part of, the specification. They illustrate embodiments of the present disclosure and, along with the description, serve to explain the principles of the disclosure. The drawings are only illustrative of certain embodiments and do not limit the disclosure.

FIG. 1 depicts a system diagram of a system for generating a set of weather triggers in a set of target areas based on current weather patterns, according to embodiments.

FIG. 2 depicts a flow diagram of a method for identifying a sphere of influence, according to embodiments.

FIG. 3 depicts a flow diagram of a method for identifying additional target areas and generating weather-based triggers for the areas, according to embodiments.

FIG. 4 depicts a flow of map images to depict the use of a series of filters to identify a robust set of target areas, according to embodiments.

FIG. 5 depicts a high-level block diagram illustrating an exemplary computer system that can be used in implementing one or more of the methods, tools, components, and any related functions described herein (e.g., using one or more processor circuits or computer processors of the computer), according to embodiments.

FIG. 6 depicts an illustrative cloud computing environment, according to embodiments.

FIG. 7 depicts a set of functional abstraction layers provided by cloud computing environment, according to embodiments.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention.

### DETAILED DESCRIPTION

Aspects of the present disclosure relate to targeted advertising, more particular aspects targeted advertising based on location and weather. While the present disclosure is not necessarily limited to such applications, various aspects of the disclosure may be appreciated through a discussion of various examples using this context.

Weather influences our mood, eating habits, choice of clothes, decisions about going out or staying inside, and so many others, often to our disbelief, our purchasing decisions. It has been show to affect how consumers feel, their moods, and thus, to an extent, their intent to make a purchase. Understanding how weather factors into influencing consumer behavior is a first step toward designing weather-based marketing campaigns.

Location and weather triggered advertising may currently lack an ability to dynamically target users. Location based advertisements may be triggered if potential consumers are within a store or within a predetermined geo-fenced area and subject to a host of regulation and privacy laws. Weather based advertisements may trigger on specific weather conditions, but they are limited in their targeting methodologies. Thus, valuable data regarding consumer trends and its distinct ties to weather patterns may be lost.

As discussed herein, while several attempts have been made to harness the power of weather-triggered advertising and location-based advertisements, none have attempted to capture, synthesize, and integrate the exponential increase in value of the two approaches used conjointly. The disclosed herein represents an improvement to a computer system in that it may use models and predetermined configurations (e.g., filters as described herein) to reduce CPU requirements in predicting buyer behavior. It also may use a combination of models (sphere of influence models, look alike models, weather-based models) to more accurately target potential customers for a particular brand in a manner that reduces computing power requirements (CPU usage) as well as time requirements (e.g., fewer delays). The disclosed herein may also improve presentation of data (e.g., weather-based triggers) in a computer system through the use of a display or UI configured according to user settings.

According to embodiments, a method, system, and computer program product may be used to dynamically identify preferred zip codes for targeted advertising based on distances traveled by users from their homes to each physical location of a brand (e.g., each brand point of interest (POI)). Their homes may be equated to their estimated sleep locations, and the physical location of a brand may be, for example, a brick-and-mortar location of a store.

The computer system may also be used to dynamically identify preferred zip codes for targeted advertising by estimating an ideal consumer characteristics based on estimated sleep locations of brand visitors and utilizing look-a-like modeling to target optimal demographic and location-based behavioral profiles for each brand.

The system may identify a preferred set of target geographic areas outside of the identified areas of influence within a Designated Marketing Area (DMA) during particular weather patterns by synthesizing geographic consumer data, location-based ping and journey data, demographic data, and weather data. First, the system may be used to identify a sphere of influence (SOI). The SOI may be a determined reach (e.g., a geographic distance in each direction) that indicates how far consumers are willing to travel to a brand's commercial point of interest (POI) (e.g., a physical location of the brand, as described herein). For example, an SOI may indicate that a consumer in a particular city will travel on average a maximum of 1.5 miles in order to reach the brand's store (i.e. the brand's commercial POI).

Additionally, a more complex analysis may be used to determine the SOI. For example, a specific zip code from which a set of users is traveling may be identified and monitored. In embodiments, a set of consumers may be travelling from their specific zip code in the suburbs into the city (e.g., to the brand POI). The system may identify the time of day, the day of the week, the type of day (e.g., weekday or weekend), the weather, or other appropriate factors that may impact a triggering of a SOI for the particular POI. In other embodiments, a SOI may identified not exclusively as a radial distance (e.g., 3 miles or 5 miles away), but rather as an identified set of zip codes, based on factors including those described herein. For example, a SOI may include a zip code about 5 miles away from the POI, but may exclude a neighboring zip code (e.g., one only 2 miles away from the POI), if the zip code is less accessible (e.g., by public transit, by well-paved roads, etc.), or if for some other reason there is less traffic from the zip code to the POI (e.g., few consumers living in the zip code, residents of the zip code who are less inclined to purchase from the brand, etc.).

Second, the system may identify a set of demographic profiles for a set of individuals within the SOI. Using look-alike modeling and the demographic profiles of consumers and those within the target areas, additional areas outside of the SOI may be identified as additional target areas. For example, a set of users outside of the 1.5 miles may have demographic data substantially similar to the some of the brands highest-value consumers inside the SOI. In some cases, based on the modeling, these consumers, via their locations of residence, may be identified as potential consumers with their locations (e.g., zip codes) identified as additional target areas for advertisement. Third, weather data may be applied, using natural language processing, to determine which advertisements for the particular brand may be best suited for each of these target areas and additional target areas during a particular weather pattern or the current weather in the location.

While this determination may be made according to various embodiments, one example is described below:

In embodiments, an SOI is calculated for all of a brand's POI in a selected portion of a geographic area (for example, a designated marketing area (DMA) may be used). First, visitors from the selected portion of the geographic area may be removed, in order to perform the calculation using primarily residents. Then, a distance traveled by users is calculated using the Haversine formula. Third, the travel distance two standard deviation above the mean is calculated. This may be known as the SOI for that particular brand's POI. Finally, all zip codes that fall within the SOI in the selected portion of the geographic area zip codes that include POI visitors and zip codes with look-a-like demographics may be selected, as described below.

In embodiments, look-alike modeling may be performed using relevant users who visit the POI for brand. In embodiments, and as described herein, a sleep location of all users is calculated utilizing the median latitude and longitude between a predetermined range of time. For example, a sleep location could be determined using the median latitude and longitude between 3 AM and 5 AM for a user. This location is then converted into a census tract (i.e., a Bureau of Census-established grouping, roughly equivalent to a neighborhood), and then to a zip code for each user. Next, the demographics at the zip code level are merged into the user data. In some embodiments, this may create a profile for a user or set of users, on an individual or zip code level of individuation. In embodiments, the demographic may include consumer, household, and neighborhood data. This demographic data may be identified using census data, or other readily available consumer data. Then, visitation rates may be calculated at each zip code level and decision tree models may be generated to find demographic threshold where brand visitation rate is highest. Finally, all zip codes within the DMA and SOI with demographic profiles that suggest higher visitation rates may be identified and selected. Embodiments as described herein may use and access data (e.g., location data) that are user-consent based and fully compliant with all applicable regulations and laws.

Finally, weather triggers are generated using the pre-selected zip codes (based on the above higher visitation based selections) and weather factors that drive higher brand visitation. In embodiments, the triggers may be generated by models trained for each DMA and season. First, the footfall at all brand POI locations in a DMA is counted on a daily basis. The POI locations may be updated on a regular basis, for example, on a monthly basis. Next, weather data may be aggregated at a daily level for historical, current, and forecasted conditions. Then, higher than and lower than median visitation days are identified for prediction. Then, a decision tree may be build utilizing weather variable to identify weather conditions that impact or increase brand visitation rates. In some embodiments, models may be adjusted or modified according to various error testing rates or accuracy thresholds. For example, models with out of sample test scores with an absolute change in 10% relative to the training set are removed. Finally trigger files are generated using rules for each DMA and season to alert in pre-selected zip codes based on the identified weather conditions in real-time when the system is called.

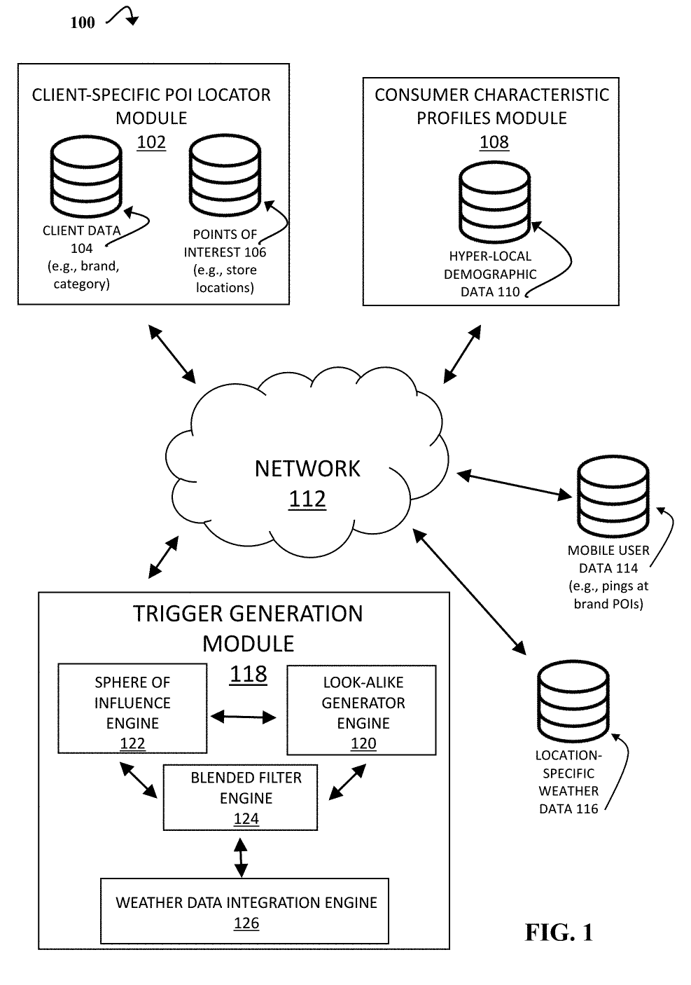

FIG. 1 depicts a system diagram of a system 100 for generating a set of weather triggers in a set of target areas based on current weather patterns, according to embodiments. System 100 of FIG. 1 is carried out on various computer processing circuits, and may include more, fewer, or different engines than those described herein.

A trigger generation module 118 may comprise a set of engines including a sphere of influence engine 122, a look-alike generator engine 120, a blended filter engine 124, and a weather data integration engine 126. These engines, as well as the other elements of the system 100 may be physically or communicatively coupled, and may communicate bidirectionally over a network or networks 112. The network 112 can include, but are not limited to, local area networks, point-to-point communications, wide area networks, the global Internet, and combinations thereof.

A client-specific POI locator module 102 may be used to query and store brand-based data for a particular client. In embodiments, a set of client data may be stored in a client data database 104. This data can include brand data including branding logos, company information, and category data related to the type of business or retail in which the particular brand engages. For example, a client data database 104 could contain the name of a brand (“NAME”) and a category in which the brand operates, (e.g., “outdoor clothing”). This data may be obtained from the client itself, from external sources including the Internet, from internally-generated processes, or in another way as appropriate to the client. In embodiments, the client-specific POI locator module 102 may also comprise a points of interest database 106, which may store data including geographic or location data, type of POI data, and other data related to the particular set of POIs for a brand. For example, the points of interest database 106 could contain a street address and a latitudinal and longitudinal coordinate set for a flagship store. In embodiments, databases 104 and 106 may be updated at regular intervals or based on changes in the POIs (e.g., an addition or loss of a POI), at an administrator request, or upon another setting-based trigger. In embodiments, a POI for a brand may be a brick-and-mortar store location for the brand, a brick-and-mortar retail location that carries the brand, a physical pop-up location for the brand, or another brand-specific physical location.

A consumer characteristic profiles module 108 may contain a hyper-local demographic database 110. The hyper-local demographic data contained in the database may contain a set of demographic data described herein, associated with a particular zip code, may comprise demographic data including consumer, household and neighborhood or zip code-specific data. The consumer characteristic profiles module 108 may compile and organize profiles for individual users or zip codes.

The consumer characteristics profile module 108 may also access mobile user data stored in a mobile user databased 114, described herein, which may include data regarding a user's location of residence, as determined by a user's median location during a predetermined period of time (e.g., during early morning hours). The mobile user database 114 may also contain data regarding a set of “pings” at each of a brand's POIs. In embodiments a broad set of “pings” for each location of the user may be filtered out to generate a set of brand-specific pings (e.g., pings at a POI for the particular brand). As used herein, ‘pings’ will refer to the filtered set of brand-specific POI check ins. A ping may be a recording of an instance (i.e., a count) of a user entering a space or a radius around a pre-identified location, in this case a POI for a particular brand. The location of the mobile user may be identified using a smart phone, laptop computer, tablet, personal fitness device, or any other suitable location-detecting device. This data may be merged by the consumer characteristic profiles module 108 with the hyper-local data from the hyper-local demographic data 110 to generate a profile or set of profiles for users entering the POIs for the particular brand.

In embodiments, the system may generate a set of profiles or ‘personas’ based on a tracking of behaviors or a set of behaviors of users and brand-specific pings. For example, a profile for a ‘commuter’ persona may be generated based on a historical or anticipated collection of behaviors (e.g., a commuter from the suburbs and his or her purchasing habits and relation to the POI). Another example may include a small business owner persona, wherein a set of behaviors relative to the brand's POI, typical to a small business owner may be generated. Other personas may be generated and stored in profile, to help with the clustering of the look-alike modeling.

The sphere of influence engine 122 of the trigger generation module 118 may also access mobile user data, for example a mobile user's pings to a POI for the particular brand, from the mobile user database 114 over the network 112, and based on the data select a distinct set of users (for example, by location, by store, by hour, etc.). For each of these users, the SOI engine 122 may then calcite average travel distances to each POI, and identify zip codes that fall within the average travel distances, as described herein. These identified zip codes may be referred to as “target areas.”

The look-alike generator engine 120 may access profile data (e.g., merged hyper-local demographic data mapped to a user's home location) and aggregate it by store, by location, and by time and the zip codes identified by the SOI engine 122. This data may be used by the look-alike generator engine 120 to train the model to find a key set of consumer characteristics. For example, the key set of consumer characteristics may reflect various demographic similarities amongst a set of consumers, for example, a set of highly-influenced or highly-active consumers for the particular brand. Thus, a group of users may be identified who demographically look and may act like those highly-influence or highly-active consumers in the original target areas. In this way, a look-alike model is generated and used to identify an additional set of geographic areas (e.g., zip codes) that most or more similarly resemble the key set of consumer characteristics more than those areas surrounding the additional set of geographic areas. The additional set of geographic areas or zip codes identified by the look-alike generator engine 120 may be referred to as additional target areas.

The blended filter engine 124 may then access the target areas identified by the sphere of influence engine 122 and the additional target areas identified by the look-alike generator engine 120, and combine the two into a robust set of brand target areas.

The weather data integration engine 126 may access location-specific weather data from a location-specific weather database 116. The location-specific weather database 116 may store weather data obtained from the Internet or other sources, for each particular store location. The data may also include time data associated with the weather data. The database 116 may also comprise a set of city-specific and season-specific data, for example a zip code-to-city mapping, as well as a set of region-specific season definitions. The weather data integration engine 126 may synthesize this data and model the effect of the weather on visitors to each store. Based on this data, the engine 126 may generate and output weather triggers. For example, a set of weather triggers may be generated and output to THE WEATHER COMPANY into a WEATHERFX product. The model used by the weather data integration engine 126 may be rerun at a particular predetermined increment (e.g., monthly), to ingest new data including demographics data, user location ping behavior and weather characteristics, to update the preferred weather variable and conditions to trigger the identified target areas inside each DMA. As discussed in more detail herein, models may be trained for each DMA and each season.

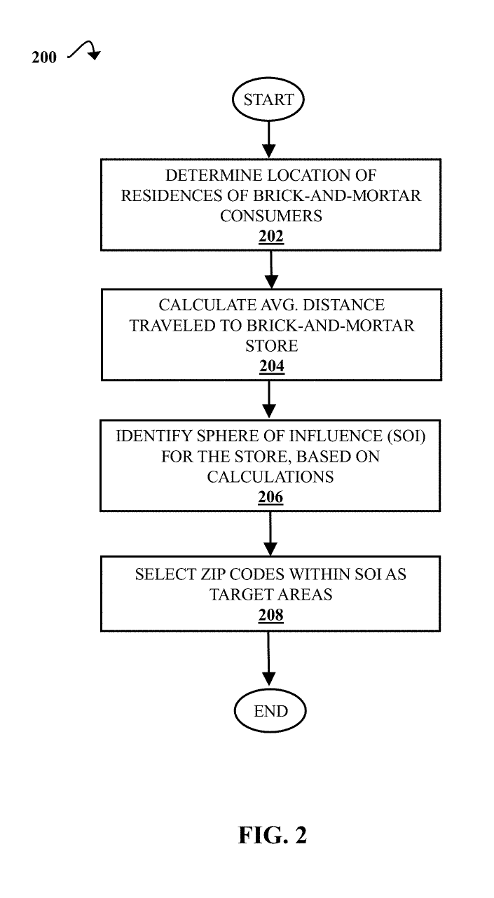

FIG. 2 depicts a flow diagram of a method 200 for identifying a sphere of influence, according to embodiments of the present disclosure. The method 200 may start by determining a location of residences of brick-and-mortar brand consumers, per 202. For example, the system may determine a street address or a latitude and longitude data set for the home of a consumer who shops at the brand's primary physical location a mile from her home. The location of the home may be determined by a users identified average location during a predetermined period of time. The user may be identified as an actual consumer at the brand's brick-and-mortar store by a ping, generated when her personal fitness device entered the store's geographic radius. The ping could also be generated based on a particular threshold of time spent in the location, based on a purchase, or based on another user-based indicator of consumer interest.

At 204, the system may calculate an average distance traveled to the brick-and-mortar store for the particular brand. This may be calculated using the haversine formula for users determined to have visited the POI, based on the user's identified location of residence. As noted herein, ‘visitors’, as defined as those determined to reside outside of the DMA, may be removed from the calculation. The travel distance one standard deviation away from the mean may be calculated. Per 206, this calculation may then be referred to as the SOI for the brand's POI (e.g., the particular store). Zip codes that fall within the identified SOI may be selected as target areas, per 208. The method 200 may end upon the selection of target areas. In embodiments, method 300 may start as a step following step 208.

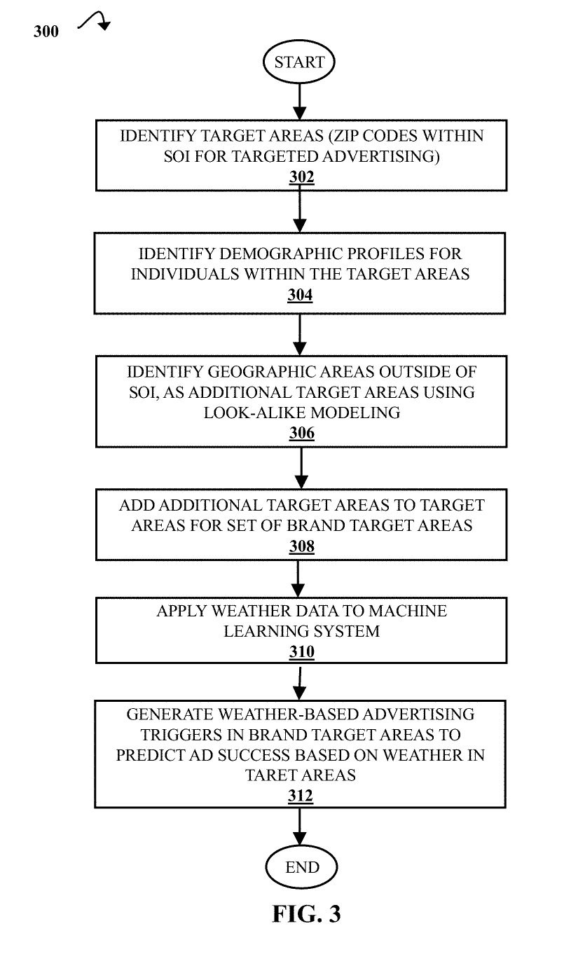

FIG. 3 depicts a flow diagram of a method 300 for identifying additional target areas and generating weather-based triggers for the areas, according to embodiments. As discussed herein, method 300 may be carried out over a series of processors and may begin at the end of method 200, using the target areas selected at 208 of method 200.

Method 300 may start with identifying a target area or areas, per 302. In embodiments, the target areas may be the zip codes within the SOI identified for targeted advertising in method 200. At 304 the system may identify demographic profiles for individuals within the target areas. See further description of how the demographic profiles for the particular individuals may be generated. The demographic data can include consumer and household purchasing data, income data, and other relevant demographic data.

Using look-alike modeling, geographic areas outside of the SOI may be identified. In embodiments, this may a calculations of visitation rates for the particular POI for the particular brand for each zip code. For example, a visitation rate could numerically describe the frequency at which residents of the particular target area visit the identified POI. A decision tree may generated to find demographic thresholds in locations where brand visitation rate is the highest, and a set of geographic areas (e.g., zip codes) with demographic profiles that correlate with those higher visitation rates may be identified. Per 306, these additional geographic areas may be identified as additional target areas. At 308, the additional target areas may be added to the previously identified set of target areas to generate a full set of brand target areas.

At 310, weather data may be applied to a machine learning system, to model weather impact on brand visitation rates. In embodiments, models may be trained for each DMA in each season. Models could be trained on various other levels of specificity, as preferred by the client. In embodiments, a daily count of the footfall (e.g., footfall) at all brand POI locations (e.g., all brick-and-mortar retail locations for a particular brand) may be taken and update on a monthly or weekly basis. Next, weather data may be aggregated on a daily level. In embodiments, time-of-day data could be aggregated along with the weather data, allowing for various levels of granularity in weather data analysis. The system may then identify higher than median visitations days for use in prediction. Using this data, a decision tree may be build using weather variables to identify weather conditions that increase brand visitation rates. Finally, rules based on the decision tree may be used to generate trigger files, which may be specific to each POI (e.g., a different trigger file for each store) and for each season (e.g., a different trigger file or set of trigger files for each store in each season), per 312. The trigger files may indicate a predicted more effective advertisement or set of advertisements for a brand's POI during a particular identified weather. Thus, a store would be notified of the preferred advertisement for based on or in anticipation of the day's weather for the identified particular user set residing in the set of target areas. The method 300 may then end. According to embodiments, the system may be updated, with triggers revised, removed, or added on a regular basis, according to system and client preferences.

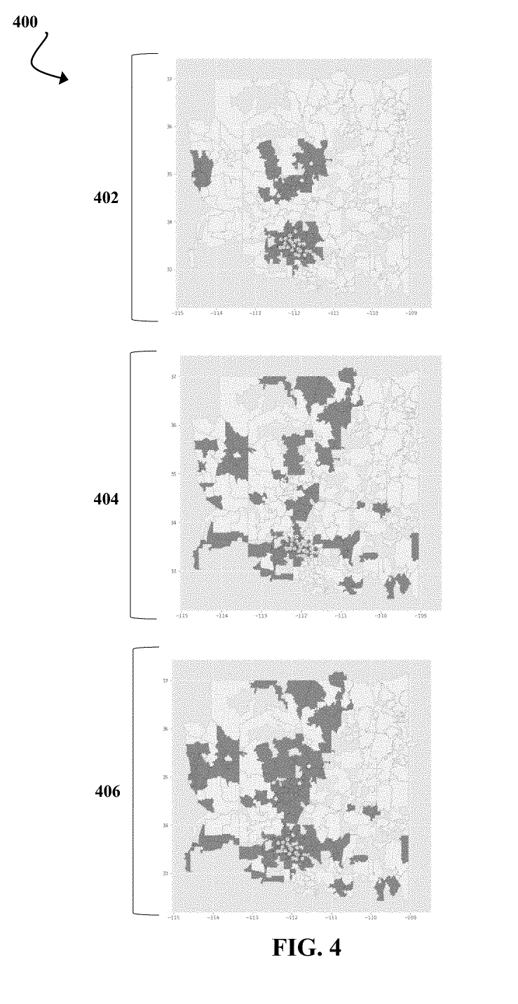

FIG. 4 depicts a flow of map images 400 to depict the use of a series of filters to identify a robust set of target areas, according to embodiments. In embodiments, the progression of images 400 may be reflective of steps 200-308, of FIGS. 2 and 3, respectively. At 402, an image of a map that represents a particular DMA is depicted. A first set of target areas (e.g., zip codes within each SOI) identified within each POI for the brand are identified by a set of darkened zip codes.

At 404, a map image depicts a set of look-alike trigger areas. This application of a look-alike model uses demographic characteristics of those consumers within the SOI, depicted at 402, to identify an additional set of target areas. The third map image at 406 depicts a combined visualization of sphere-of-influenced based target area identification and look-alike model based additional target area identification. The combined set of darkened zip codes indicate a full set of targeted areas for effective trigger-based advertisements.

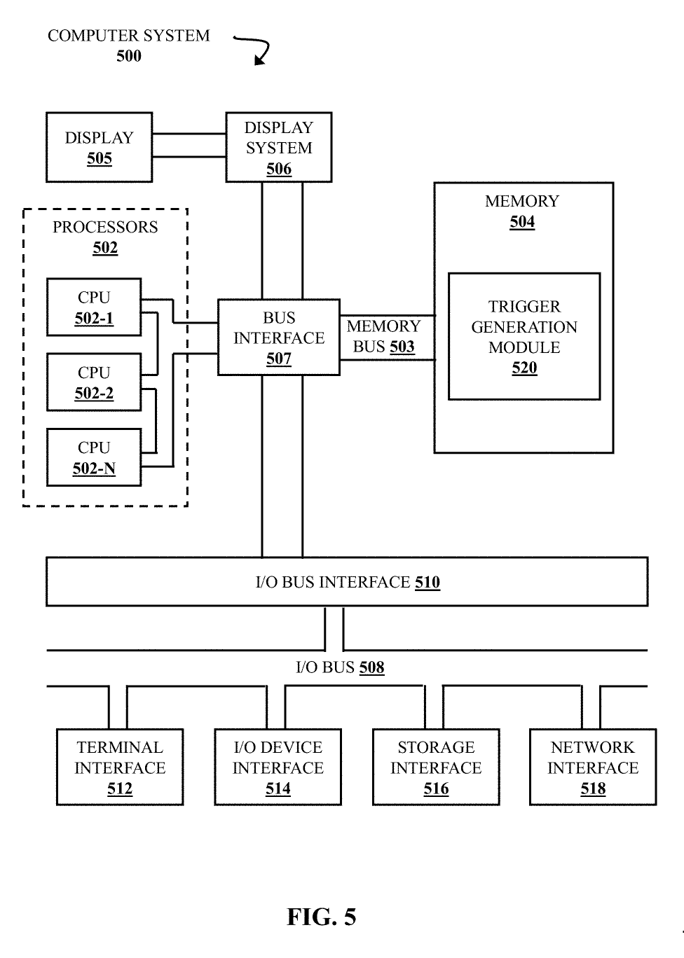

FIG. 5 is a high-level block diagram illustrating an exemplary computer system 500 that can be used in implementing one or more of the methods, tools, components, and any related functions described herein (e.g., using one or more processor circuits or computer processors of the computer). In some embodiments, the major components of the computer system 500 comprise one or more processors 502, a memory subsystem 504, a terminal interface 512, a storage interface 516, an input/output device interface 514, and a network interface 518, all of which can be communicatively coupled, directly or indirectly, for inter-component communication via a memory bus 503, an input/output bus 508, bus interface unit 507, and an input/output bus interface unit 510.

The computer system 500 contains one or more general-purpose programmable central processing units (CPUs) 502-1, 502-2, and 502-N, herein collectively referred to as the CPU 502. In some embodiments, the computer system 500 contains multiple processors typical of a relatively large system; however, in other embodiments the computer system 500 can alternatively be a single CPU system. Each CPU 502 may execute instructions stored in the memory subsystem 510 and can include one or more levels of on-board cache.

The memory 504 can include a random-access semiconductor memory, storage device, or storage medium (either volatile or non-volatile) for storing or encoding data and programs. In some embodiments, the memory 504 represents the entire virtual memory of the computer system 500, and may also include the virtual memory of other computer systems coupled to the computer system 500 or connected via a network. The memory 504 is conceptually a single monolithic entity, but in other embodiments the memory 504 is a more complex arrangement, such as a hierarchy of caches and other memory devices. For example, memory may exist in multiple levels of caches, and these caches may be further divided by function, so that one cache holds instructions while another holds non-instruction data, which is used by the processor or processors. Memory can be further distributed and associated with different CPUs or sets of CPUs, as is known in any of various so-called non-uniform memory access (NUMA) computer architectures.

These components are illustrated as being included within the memory 504 in the computer system 500. However, in other embodiments, some or all of these components may be on different computer systems and may be accessed remotely, e.g., via a network. The computer system 500 may use virtual addressing mechanisms that allow the programs of the computer system 500 to behave as if they only have access to a large, single storage entity instead of access to multiple, smaller storage entities. Further, although these components are illustrated as being separate entities, in other embodiments some of these components, portions of some of these components, or all of these components may be packaged together.

In an embodiment, the trigger generation module 520 includes instructions that execute on the processor 502 or instructions that are interpreted by instructions that execute on the processor 502 to carry out the functions as further described in this disclosure. In another embodiment, the trigger generation module 520 is implemented in hardware via semiconductor devices, chips, logical gates, circuits, circuit cards, and/or other physical hardware devices in lieu of, or in addition to, a processor-based system. In another embodiment, the trigger generation module 520 includes data in addition to instructions. In embodiments, trigger generation module 520 may be the trigger generation module 118 of FIG. 1.

Although the memory bus 503 is shown in FIG. 5 as a single bus structure providing a direct communication path among the CPUs 502, the memory subsystem 510, the display system 506, the bus interface 507, and the input/output bus interface 510, the memory bus 503 can, in some embodiments, include multiple different buses or communication paths, which may be arranged in any of various forms, such as point-to-point links in hierarchical, star or web configurations, multiple hierarchical buses, parallel and redundant paths, or any other appropriate type of configuration. Furthermore, while the input/output bus interface 510 and the input/output bus 508 are shown as single respective units, the computer system 500 may, in some embodiments, contain multiple input/output bus interface units 510, multiple input/output buses 508, or both. Further, while multiple input/output interface units are shown, which separate the input/output bus 508 from various communications paths running to the various input/output devices, in other embodiments some or all of the input/output devices may be connected directly to one or more system input/output buses.

The computer system 500 may include a bus interface unit 507 to handle communications among the processor 502, the memory 504, a display system 506, and the input/output bus interface unit 510. The input/output bus interface unit 510 may be coupled with the input/output bus 508 for transferring data to and from the various input/output units. The input/output bus interface unit 510 communicates with multiple input/output interface units 512, 514, 516, and 518, which are also known as input/output processors (IOPs) or input/output adapters (IOAs), through the input/output bus 508. The display system 506 may include a display controller. The display controller may provide visual, audio, or both types of data to a display device 505. The display system 506 may be coupled with a display device 505, such as a standalone display screen, computer monitor, television, or a tablet or handheld device display. In alternate embodiments, one or more of the functions provided by the display system 506 may be on board a processor 502 integrated circuit. In addition, one or more of the functions provided by the bus interface unit 507 may be on board a processor 502 integrated circuit.

In some embodiments, the computer system 500 is a multi-user mainframe computer system, a single-user system, or a server computer or similar device that has little or no direct user interface, but receives requests from other computer systems (clients). Further, in some embodiments, the computer system 500 is implemented as a desktop computer, portable computer, laptop or notebook computer, tablet computer, pocket computer, telephone, smart phone, network switches or routers, or any other appropriate type of electronic device.

It is noted that FIG. 5 is intended to depict the representative major components of an exemplary computer system 500. In some embodiments, however, individual components may have greater or lesser complexity than as represented in FIG. 5, Components other than or in addition to those shown in FIG. 5 may be present, and the number, type, and configuration of such components may vary.

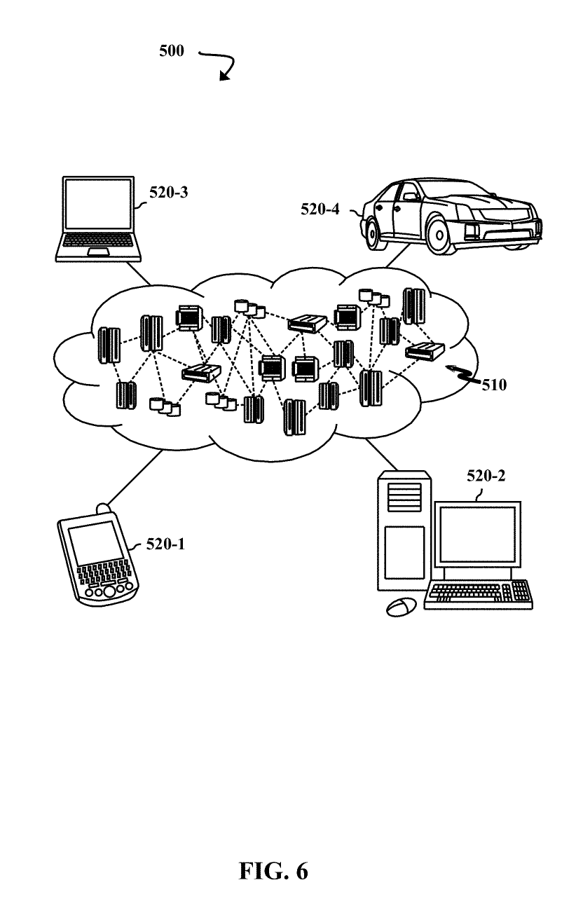

In some embodiments, the data storage and retrieval processes described herein could be implemented in a cloud computing environment, which is described below with respect to FIGS. 5 and 6. It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

Referring now to FIG. 6, illustrative cloud computing environment 600 is depicted. As shown, cloud computing environment 600 includes one or more cloud computing nodes 610 with which local computing devices used by cloud consumers, such as, for example, personal digital assistant (PDA) or cellular telephone 620-1, desktop computer 620-2, laptop computer 620-3, and/or automobile computer system 620-4 may communicate. Nodes 610 may communicate with one another. They may be grouped (not shown) physically or virtually, in one or more networks, such as Private, Community, Public, or Hybrid clouds as described hereinabove, or a combination thereof. This allows cloud computing environment 600 to offer infrastructure, platforms and/or software as services for which a cloud consumer does not need to maintain resources on a local computing device. It is understood that the types of computing devices 620-1-620-4 shown in FIG. 6 are intended to be illustrative only and that computing nodes 610 and cloud computing environment 600 can communicate with any type of computerized device over any type of network and/or network addressable connection (e.g., using a web browser).

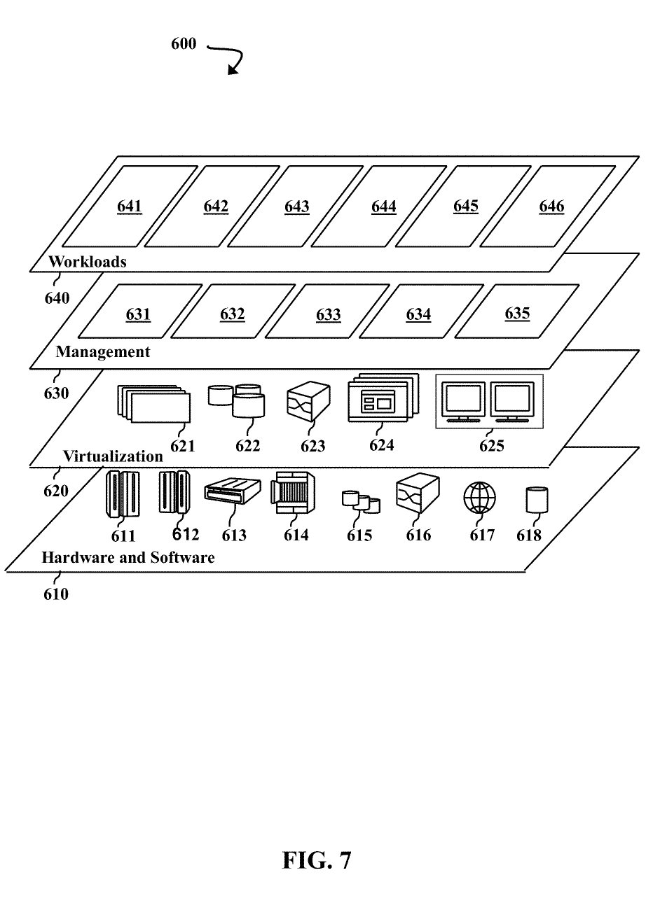

Referring now to FIG. 7, a set of functional abstraction layers 600 provided by cloud computing environment 700 (FIG. 7) is shown. It should be understood in advance that the components, layers, and functions shown in FIG. 6 are intended to be illustrative only and embodiments of the invention are not limited thereto. As depicted, the following layers and corresponding functions are provided:

Hardware and software layer 710 includes hardware and software components. Examples of hardware components include: mainframes 711; RISC (Reduced Instruction Set Computer) architecture based servers 712; servers 713; blade servers 714; storage devices 715; and networks and networking components 716. In some embodiments, software components include network application server software 717 and database software 718.

Virtualization layer 720 provides an abstraction layer from which the following examples of virtual entities may be provided: virtual servers 721; virtual storage 722; virtual networks 723, including virtual private networks; virtual applications and operating systems 724; and virtual clients 725.

In one example, management layer 730 provides the functions described below. Resource provisioning 731 provides dynamic procurement of computing resources and other resources that are utilized to perform tasks within the cloud computing environment. Metering and Pricing 732 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 733 provides access to the cloud computing environment for consumers and system administrators. Service level management 734 provides cloud computing resource allocation and management such that required service levels are met. Service Level Agreement (SLA) planning and fulfillment 635 provide pre-arrangement for, and procurement of, cloud computing resources for which a future requirement is anticipated in accordance with an SLA.

Workloads layer 740 provides examples of functionality for which the cloud computing environment can be utilized. Examples of workloads and functions that can be provided from this layer include: mapping and navigation 741; software development and lifecycle management 742; virtual classroom education delivery 743; data analytics processing 744; transaction processing 745; and machine learning for reaction rule database correction 746.

The present disclosure may be a system, a method, and/or a computer program product. The computer program product may include a computer readable storage medium (or media) having computer readable program instructions thereon for causing a processor to carry out aspects of the present disclosure.

The computer readable storage medium is a tangible device that can retain and store instructions for use by an instruction execution device. Examples of computer readable storage media can include an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network can comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a component, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for identifying a preferred geographic area for a targeted advertising of a given brand to a target consumer, the method comprising:
determining a set of locations of residence of actual consumers, wherein the actual consumers have visited a particular physical location of the given brand;
calculating, based on the set of locations of residences, an actual distance traveled to the particular physical location of the given brand for actual customers;
identifying, based on the calculating, a sphere of influence (SOI) for the particular physical location; and
selecting a set of geographic areas within the SOI as target areas, wherein target areas are areas in which to perform the targeted advertising for the particular brand.

2. The method of claim 1, further comprising:
identifying a set of demographic profiles for a set of individuals within the target areas;
applying, to the demographic profiles, a look-alike model to identify additional geographic areas outside of the SOI, wherein the additional geographic areas are demographically similar to the target areas; and
selecting the additional geographic areas as additional target areas, wherein the additional target areas are areas outside of the SOI in which to perform the targeted advertising.

3. The method of claim 1, further comprising:
applying, to a machine learning system, weather data; and
identifying, based on the applying the weather data, a set of weather-based advertising triggers, wherein the weather-based advertising triggers are predictive of which particular set of advertisements are preferred for a current weather pattern in the target areas.

4. The method of claim 1, wherein the determining the set of locations of residence of actual consumers comprises:
identifying a median geographic location of a user during a predetermined time period;
converting, to a zip code, the geographic location and assigning the geographic location as a location of residence for the user;
determining, using a set of mobile user data, the user is an actual consumer for the particular brand; and
assigning, as a data point in the set of locations of residence of actual consumers, the location of residence for the user.

5. The method of claim 1, wherein the SOI comprises a set of geographic areas outside of a set radial distance.

6. The method of claim 3, wherein a trigger in the set of weather-based advertising triggers is a forecasted prediction of precipitation.

7. The method of claim 1, wherein the particular physical location of the brand is a retail store.

8. A system comprising:
a sphere of influence engine configured to:
determine a set of locations of residence of actual consumers, wherein the actual consumers have visited a particular physical location of the given brand;
calculate, based on the set of locations of residences, an actual distance traveled to the particular physical location of the given brand for actual customers;
identify, based on the calculating, a sphere of influence (SOI) for the particular physical location; and
select a set of geographic areas within the SOI as target areas, wherein target areas are areas in which to perform the targeted advertising for the particular brand.

9. The system of claim 8, further comprising:
a look-alike generator engine configured to:
identify a set of demographic profiles for a set of individuals within the target areas;
apply, to the demographic profiles, a look-alike model to identify additional geographic areas outside of the SOI, wherein the additional geographic areas are demographically similar to the target areas; and
a blended filter engine configured to:
select the additional geographic areas as additional target areas, wherein the additional target areas are areas outside of the SOI in which to perform the targeted advertising.

10. The system of claim 8, further comprising:
a weather data integration engine configured to:
apply, to a machine learning system, weather data; and
identify, based on the applying the weather data, a set of weather-based advertising triggers, wherein the weather-based advertising triggers are predictive of which particular set of advertisements are preferred for a current weather pattern in the target areas.

11. The system of claim 8, wherein the determining the set of locations of residence of actual consumers by the sphere of influence engine comprises:
identifying a median geographic location of a user during a predetermined time period;
converting, to a zip code, the geographic location and assigning the geographic location as a location of residence for the user;
determining, using a set of mobile user data, the user is an actual consumer for the particular brand; and
assigning, as a data point in the set of locations of residence of actual consumers, the location of residence for the user.

12. The system of claim 8, wherein the SOI comprises a set of geographic areas outside of a set radial distance.

13. The system of claim 10, wherein the trigger in the set of weather-based advertising triggers identified by the weather data integration engine is a forecasted prediction of precipitation.

14. The system of claim 8, wherein the particular physical location of the brand is a retail store.

15. A computer program product comprising a computer readable storage medium having program instructions embodied therewith, wherein the computer readable storage medium is not a transitory signal per se, the program instructions executable by a processor to cause the processor to perform a method comprising:
determining a set of locations of residence of actual consumers, wherein the actual consumers have visited a particular physical location of the given brand;
calculating, based on the set of locations of residences, an actual distance traveled to the particular physical location of the given brand for actual customers;
identifying, based on the calculating, a sphere of influence (SOI) for the particular physical location; and
selecting a set of geographic areas within the SOI as target areas, wherein target areas are areas in which to perform the targeted advertising for the particular brand.

16. The computer program product of claim 15, the method further comprising:
identifying a set of demographic profiles for a set of individuals within the target areas;
applying, to the demographic profiles, a look-alike model to identify additional geographic areas outside of the SOI, wherein the additional geographic areas are demographically similar to the target areas; and
selecting the additional geographic areas as additional target areas, wherein the additional target areas are areas outside of the SOI in which to perform the targeted advertising.

17. The computer program product of claim 15, the method further comprising:
applying, to a machine learning system, weather data; and
identifying, based on the applying the weather data, a set of weather-based advertising triggers, wherein the weather-based advertising triggers are predictive of which particular set of advertisements are preferred for a current weather pattern in the target areas.

18. The computer program product of claim 15, wherein the determining the set of locations of residence of actual consumers comprises:
identifying a median geographic location of a user during a predetermined time period;
converting, to a zip code, the geographic location and assigning the geographic location as a location of residence for the user;
determining, using a set of mobile user data, the user is an actual consumer for the particular brand; and
assigning, as a data point in the set of locations of residence of actual consumers, the location of residence for the user.

19. The computer program product of claim 15, wherein the SOI comprises a set of geographic areas outside of a set radial distance.

20. The computer program product of claim 17, wherein a trigger in the set of weather-based advertising triggers is a forecasted prediction of precipitation.

21. The computer program product of claim 15, wherein the particular physical location of the brand is a retail store.
